(19) United States
(12) Patent Application Publication
(10) Pub. No.: US 2017/0046734 A1
(43) Pub. Date: Feb. 16, 2017

(54) ENHANCING TOUCHPOINT ATTRIBUTION ACCURACY USING OFFLINE DATA ONBOARDING

(71) Applicants: Anto Chittilappilly, Waltham, MA (US); Parameshvyas Laxminarayan, Needham, MA (US); Payman Sadegh, Alpharetta, GA (US)

(72) Inventors: Anto Chittilappilly, Waltham, MA (US); Parameshvyas Laxminarayan, Needham, MA (US); Payman Sadegh, Alpharetta, GA (US)

(21) Appl. No.: 14/823,670

(22) Filed: Aug. 11, 2015

(51) Int. Cl. G06Q 30/02

(52) U.S. Cl. CPC G06Q 30/0246

(57) ABSTRACT

A method, system, and computer program product for forming correlations and measurements between online data items and offline data items. An online and offline touchpoint attribution model is constructed by collating user records that correspond to an audience of online users taken from an audience of users that have interacted with both online and offline touchpoints. Individual user interactions with particular touchpoints are codified as touchpoint records. Online user interactions are captured from online observations taken at the time of the interaction. Offline user interactions are collected by an agent and are imported into the attribution model. A set of transitions through both online and offline touchpoints can be aggregated to form commonly-traversed progression paths through touchpoints that reach a conversion event. A contribution value that quantifies influence attributable to each of the respective ones of the touchpoints is calculated and used to manage makeup and spending in media plans.

### FIELD OF THE INVENTION

The disclosure relates to techniques for forming correlations and measurements between online user behavior data items and offline user behavior data items and more particularly to techniques for enhancing touchpoint attribution accuracy using offline data onboarding.

### BACKGROUND

Current marketing and advertising campaigns involve many channels (e.g., online display ads, TV ads, radio spots, newspaper ads, etc.) and often involve many different types of exposures to a brand and/or product (e.g., touchpoints). The combination of channels and touchpoints are selected by a marketing manager with the intent to increase the propensity of a user (e.g., prospect) to convert (e.g., buy a product, etc.) or otherwise advance to some other engagement state (e.g., brand introduction, brand awareness, etc.). Each user or group (e.g., segments) of users might reach conversion or such other states through different combinations of touchpoints. In such cases, the marketing manager of today desires to learn exactly which touchpoints contributed the most to conversions and/or engagement advancement in order to appropriately allocate the marketing budget to those tactics.

For example, a user might be on an airplane flipping through the pages of an inflight shopping catalog and discover an intriguing product advertisement with an associated QR code. The user might scan the QR code with a tablet connected to the airplane WiFi, which invokes a mobile microsite that features an interactive product demonstration. After watching the demo, the user might visit the manufacturer's website to discover more details about the product. After landing, the user might then receive an email from a retailer mentioning the user's product inquiry and offering a “10% Off” digital coupon. The user might then take action to visit the local store of the retailer and use the coupon to purchase the product. To start using the product, particularly as it relates to software, the user might be further required to go to the manufacturer's website to register and activate the product.

In this example, a marketing manager might conclude that the offline conversion of the user at the retail store is inherently “untrackable”, with no opportunity to correlate the conversion to the various related touchpoints experienced by the user. Legacy approaches have indeed been challenged in correlating online activity with offline purchases. For example, legacy approaches that consider only online user data might track the user's path through receiving the digital coupon, but have no record of the offline conversion at the retail store. Relying on legacy approaches, the marketing manager might incorrectly conclude that the recorded touchpoints (e.g., ad with QR code, microsite demonstration, and email digital coupon) were ineffective in converting the user. Further, legacy approaches for tracking offline activity (e.g., customer relationship management (CRM) systems) might record the product purchase, coupon usage, and activation, but be unaware of the online touchpoints along the path to conversion. With such legacy approaches, the marketing manager might overstate the conversion contribution attributed to the digital coupon.

Techniques are therefore needed to address the problem of measuring the influence of both offline touchpoints and online touchpoints on user conversion. None of the aforementioned legacy approaches achieve the capabilities of the herein-disclosed techniques for enhancing touchpoint attribution accuracy by using both offline touchpoints and online touchpoints. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for enhancing touchpoint attribution accuracy using offline data onboarding.

An online and offline touchpoint attribution model is constructed by collating user records that correspond to an audience of online users taken from an audience of users that have interacted with both online and offline touchpoints. Individual user interactions with a particular touchpoints are codified into electronic interaction touchpoint records. Online user interactions are captured from online observations and measurements taken at the time of the interaction. Contemporaneously, user interactions from offline touchpoints are measured and collected by an agent. The offline touchpoint interactions from offline interactions are imported into the attribution model. A set of transitions through both online and offline touchpoints can be aggregated to form commonly-traversed progression paths through touchpoints that reach a conversion event. A contribution value that quantifies a measure of influence attributable to each of the respective ones of the touchpoints is calculated and used to manage makeup and spending in media plans.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1 presents an environment in which techniques and components of the present disclosure can operate to enhance touchpoint attribution accuracy using offline data onboarding.

FIG. 2A presents an engagement stack progression chart including offline and online touchpoints as used in systems for enhancing touchpoint attribution accuracy using offline data onboarding, according to an embodiment.

FIG. 2B1 and FIG. 2B2 present engagement stack contribution value charts as used in systems for enhancing touchpoint attribution accuracy using offline data onboarding, according to some embodiments.

FIG. 3A and FIG. 3B present an audience segment attribution model as used in systems for enhancing touchpoint attribution accuracy using offline data onboarding, according to some embodiments.

FIG. 4 is a block diagram of a system for enhancing touchpoint attribution accuracy using offline data onboarding, according to an embodiment.

FIG. 5A depicts a diagrammatic representation of a machine in the exemplary form of a computer system within which a set of instructions for causing the machine to perform any one of the methodologies discussed herein may be executed for implementing embodiments of the present disclosure.

FIG. 5B and FIG. 5C depict block diagrams of market data processing systems suitable for implementing instances of the herein-disclosed techniques.

### DETAILED DESCRIPTION

### Overview

Current marketing and advertising campaigns involve many channels (e.g., online display ads, TV ads, radio spots, newspaper ads, etc.) and involve many types of exposures to a brand and/or product (e.g., touchpoints). The combination of channels and touchpoints are selected by a marketing manager with the intent to increase the propensity of a user (e.g., prospect) to convert (e.g., buy a product, etc.) or otherwise advance to some other engagement state (e.g., brand introduction, brand awareness, etc.). Each user or group (e.g., segments) of users might reach conversion or such other states through different combinations of touchpoints. In such cases, the marketing manager of today desires to learn exactly which touchpoints contributed the most to conversions and/or engagement advancement in order to appropriately allocate the marketing budget to those tactics.

In one example, a user might experience the following touchpoints before purchasing a product at a physical retail store: a catalog ad with a QR code, a mobile microsite product demo, the product's manufacturer site, and/or an email with a digital coupon. In this example, a marketing manager might conclude that the offline conversion of the user at the retail store is inherently “untrackable”, with no opportunity to correlate the conversion to the various related touchpoints experienced by the user. Legacy approaches have indeed been challenged in correlating online activity with offline purchases. Techniques are therefore needed to address the problem of measuring the influence of both offline touchpoints and online touchpoints on user conversion.

The herein disclosed techniques address the problem of measuring the influence of both offline touchpoints and online touchpoints on user conversion by enhancing touchpoint attribution accuracy using offline data onboarding. More specifically, the techniques described herein discuss (1) identifying users comprising an audience for various marketing campaigns; (2) identifying servers configured to receive and process electronic data records; (3) identifying touchpoints comprising offline touchpoints and online touchpoints that are presented to the users in the marketing campaigns; (4) receiving electronic data records comprising online response data derived from the online responses of the users to the online touchpoints; (5) receiving electronic data records comprising offline response data derived from the offline responses of the users to the offline touchpoints; and (6) calculating contribution values for the touchpoints that indicate a measure of the influence attributed to the touchpoints in transitioning the users from a first engagement state to a second engagement state.

In one or more embodiments, the techniques described herein further discuss determining contributing touchpoints for an audience segment, wherein the contributing touchpoints are determined based on one of the contribution values of the contributing touchpoints, the users comprising the audience segment or the initial engagement state associated with the audience segment. Still further, techniques for apportioning media spend based on the contribution values of the touchpoints are discussed.

### DEFINITIONS

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

### Solutions Rooted in Technology

The appended figures and discussion herein provides disclosure sufficient to make and use systems, methods, and computer program products that address the aforementioned issues with legacy approaches. More specifically, the present disclosure provides a detailed description of techniques used in systems, methods, and in computer program products for enhancing touchpoint attribution accuracy using offline data onboarding. Certain embodiments are directed to technological solutions for onboarding offline data to combine with online data in a user engagement stack, and measuring the conversion contribution of each offline and online touchpoint in the stack, which embodiments advance the relevant technical fields as well as advancing peripheral technical fields. The disclosed embodiments modify and improve over legacy approaches. In particular, the herein-disclosed techniques provide technical solutions that address the technical problems attendant to measuring the influence of both offline touchpoints and online touchpoints on user conversion.

Reference is now made in detail to certain embodiments. The disclosed embodiments are not intended to be limiting of the claims.

### DESCRIPTIONS OF EXEMPLARY EMBODIMENTS

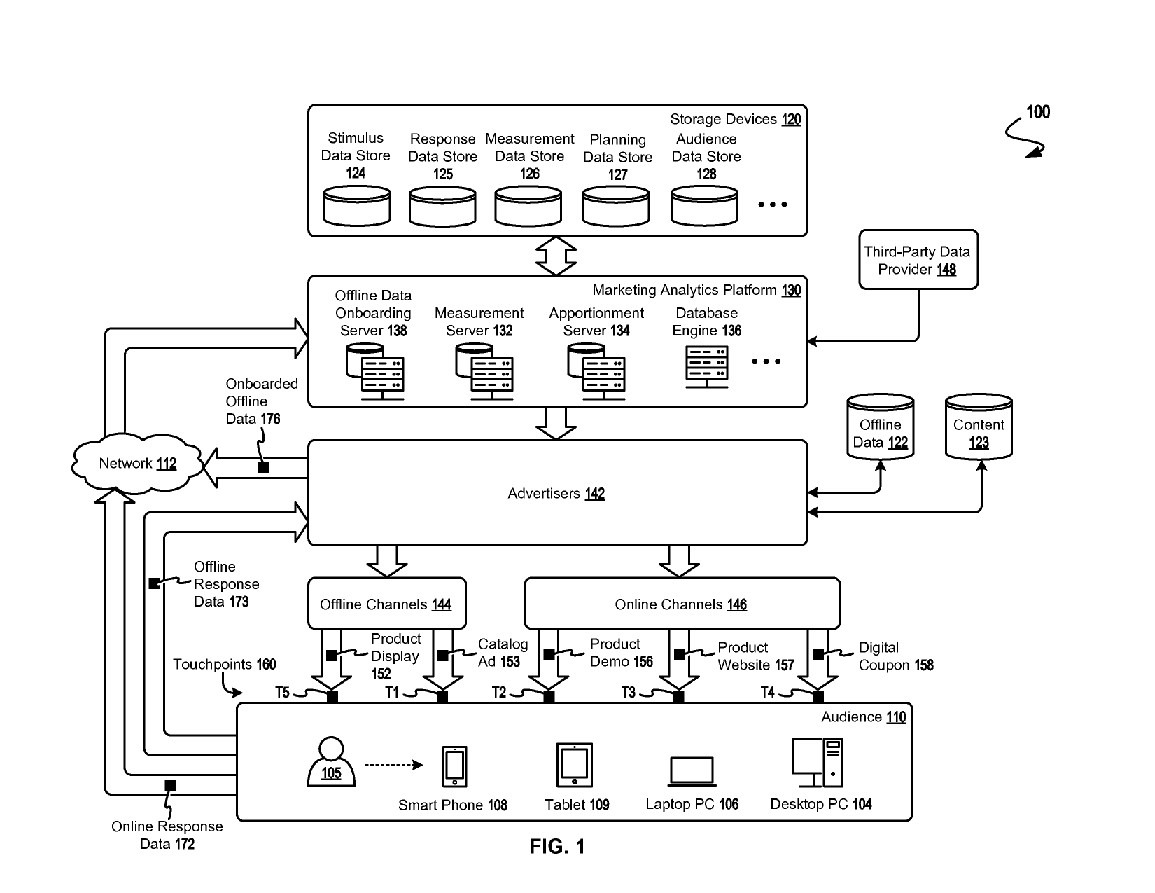

FIG. 1 presents an environment 100 in which techniques and components of the present disclosure can operate to enhance touchpoint attribution accuracy using offline data onboarding. As an option, one or more instances of environment 100 or any aspect thereof may be implemented in the context of the architecture and functionality of the embodiments described herein.

The shown environment depicts one instance of a user 105 in an audience 110 that might be targeted by one or more advertisers 142 in various marketing campaigns. The user 105 can view a plurality of content 123 on a computing device (e.g., desktop PC 104, laptop PC 106, smart phone 108, tablet 109, etc.). The plurality of content 123 can be provided by the advertisers 142 through any of a plurality of online channels 146 (e.g., online display, search, mobile ads, etc.) and/or a plurality of offline channels 144 (e.g., TV, radio, print, etc.). Stimuli from the online channels 146 and offline channels 144 comprise instances of touchpoints 160 experienced by the user 105. As an example, a product display 152 at a retail store (e.g., touchpoint T5), and/or a catalog ad 153 (e.g., touchpoint T1) on an airplane might be delivered through the offline channels 144. Further, the online channels 146 might present to the user 105 a product demo 156 on a mobile microsite (e.g., touchpoint T2), a product website 157 (e.g., touchpoint T3), and/or a digital coupon 158 in an email message (e.g., touchpoint T4).

According to one implementation, a marketing analytics platform 130 can receive instances of online response data 172 (e.g., touchpoint data, event data, user attribute data, etc.) via network 112 describing, in part, the online response of the user 105 to one or more online touchpoints. A third-party data provider 148 can further provide data (e.g., user behaviors, user demographics, cross-device mapping, etc.) to the marketing analytics platform 130. The collected data can be stored in one or more storage devices 120 (e.g., stimulus data store 124, response data store 125, measurement data store 126, planning data store 127, audience data store 128, etc.), which are made accessible by a database engine 136 to a measurement server 132 and an apportionment server 134. Operations performed by the measurement server 132 and the apportionment server 134 can vary widely by embodiment. As an example, the measurement server 132 can be used to analyze the stimulus data store 124 and response data store 125 to determine various performance metrics associated with a marketing campaign, storing such performance metrics and related data in measurement data store 126. Further, for example, the apportionment server 134 can be used to generate marketing campaign plans and associated marketing spend apportionment, storing such information in the planning data store 127.

As shown, certain instances of offline response data 173 can also be received by the advertisers and stored as offline data 122. Such instances of offline response data 173 describes, in part, the offline response of the user 105 to one or more offline touchpoints. For example, the offline data 122 might comprise CRM data such as order records, order quantities, order prices, offer codes, and other information. Further, such instances of offline data 122 can be used by the herein disclosed techniques for enhancing touchpoint attribution accuracy using offline data onboarding. Specifically, certain instances of the offline data 122 can be received by an offline data onboarding server 138 in the marketing analytics platform 130. Such instances of onboarded offline data 176 can be included with the online response data 172 when performing various analytical operations (e.g., marketing campaign performance measurement, marketing campaign planning, etc.). For example, the user 105 might experience the touchpoints 160 (e.g., T1 followed by T2, followed by T3, followed by T4, followed by T5) before purchasing a product at a physical retail store. Using the herein disclosed techniques for enhancing touchpoint attribution accuracy using offline data onboarding, the advertiser (e.g., retailer who owns the retail store) can connect the in-store purchase with all the previous marketing touchpoints (e.g., touchpoints 160) exposed to the user 105, using only non-personally identifiable information (e.g., non-PII).

For example, the retailer can record information about the inflight catalog comprising the catalog ad 153 (e.g., issue number, airline, class of travel, etc.), the microsite comprising the product demo 156 visited on the tablet 109, the email comprising the digital coupon 158 received on the laptop PC 106, the smart phone 108 used to show the digital coupon 158 at the store, and product registration and activation numbers the user 105 completed on the desktop PC 104. Moreover, the retailer would also be able to link all the marketing touchpoints the user 105 was exposed to before the trip—potentially adding up to dozens or even hundreds of online and offline interactions. The online touchpoints and offline touchpoints can be associated (e.g., linked, connected, etc.) by various indexes such as a digital cookie, a catalog identifier or ID, and/or other indexes.

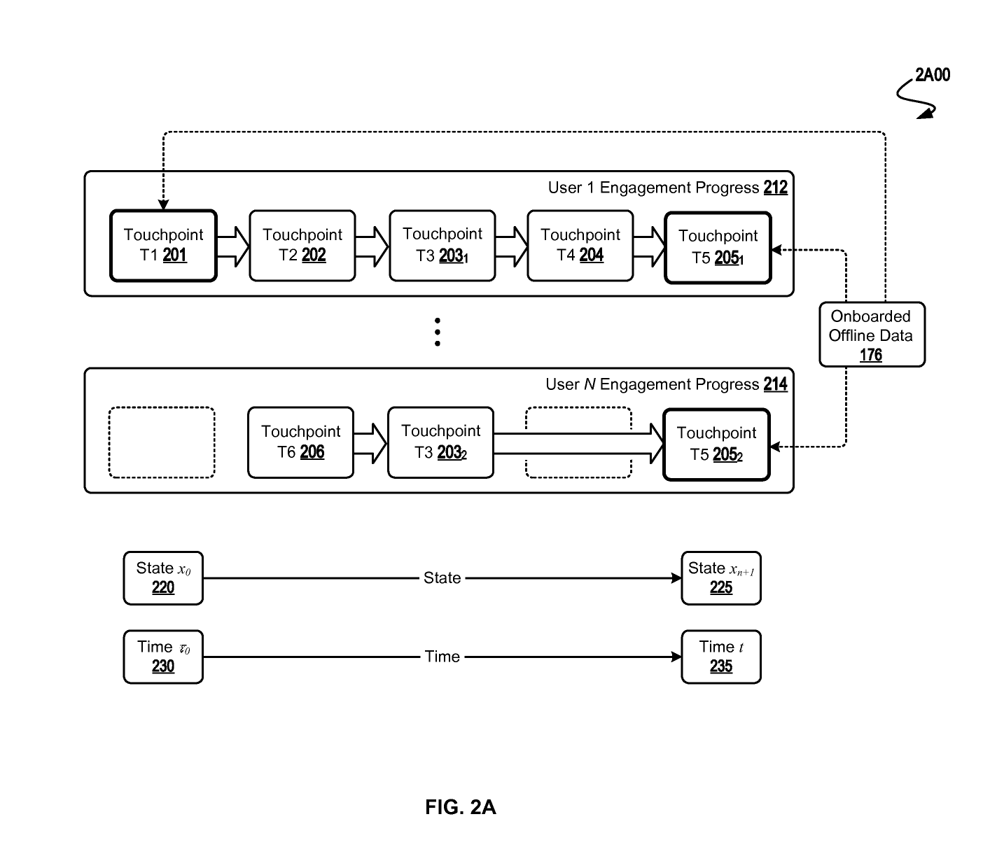

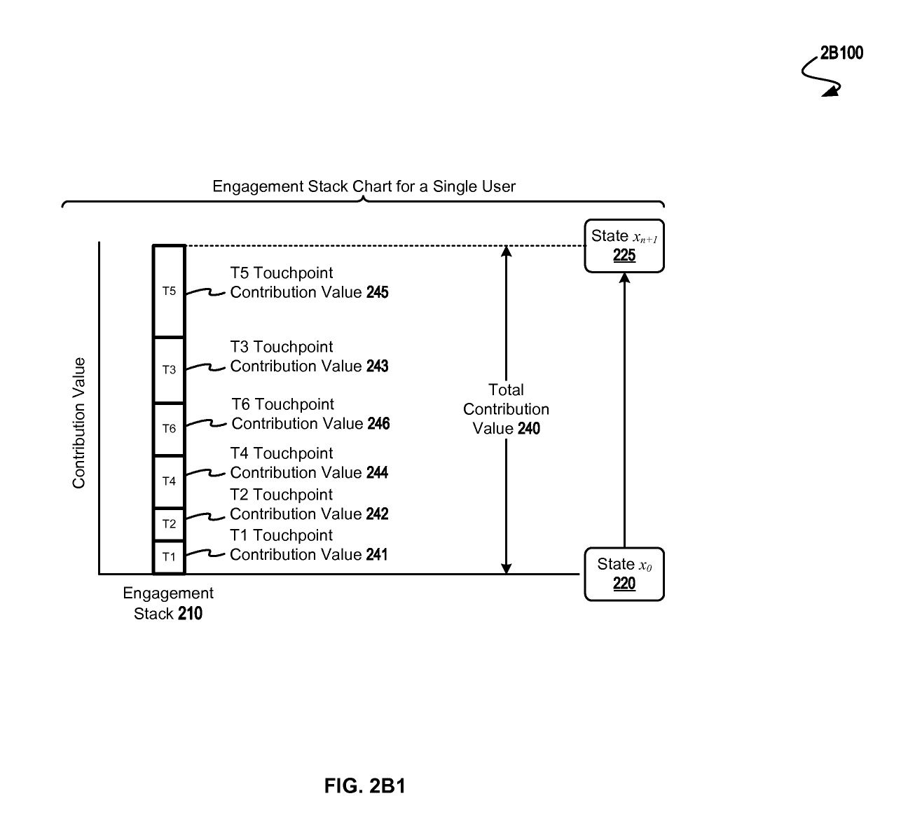

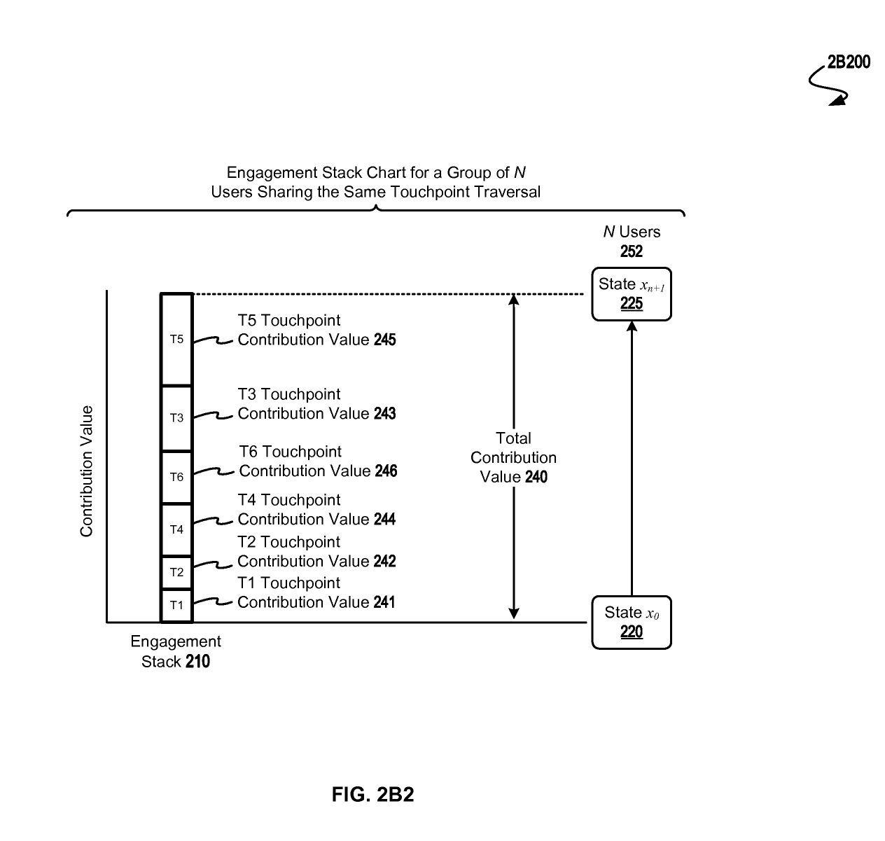

If the user 105 is an existing customer of the retailer, and chose to “opt-in” to certain data management programs and activities, the retailer can further use the herein disclosed techniques to connect the user's unique identifier (e.g., user ID) associated with certain user non-PII (e.g., demographic information, geographic information, etc.) to all the direct mail, catalogs, and emails the user 105 received over the years, and integrate such historical data into the user's journey to the offline purchase. By digitally onboarding the information associated with all their customers, the retailer can have a large volume of data that can be used to accurately measure the impact of each marketing channel and tactic, and optimize media investments to yield the best returns. When an offline user is a new customer, a “post-conversion” onboarding process can be applied to connect the user to available historical information such as non-PII information pertaining to the same user (or pertaining to a user that is suspected to be the same user). For example, after making an in-store purchase (e.g., in an offline setting), the offline product purchase by an in-store customer is registered in the point-of-sale (POS) system at the store, which is linked with a centralized backend database system that assigns a userID to the newly-registered customer. Thereafter, the customer is sent an email on their registered email address (e.g., see, touchpoint T4 204 of FIG. 2) that provides a web link offering a discount as a reward for going online and signing-up for a product warrantee. Either the web link or the sign-up process interface pages would have the newly-assigned userID embedded into a tracking pixel that logs aspects of the digital online event (e.g., the product warrantee sign-up event) and associates the digital online event with a different ID that is non-PII (e.g., a hashed email alias or other obfuscated user identification). The association serves to connect the in-store customer's offline events (e.g., the offline product purchase) with other online events. Such an approach enables the retailer to see the entire past history of media consumption (e.g., both online and offline) and how those touchpoints influenced conversion activity. As discussed, the integration of customer data and advertising data can be performed in a privacy-conscious way. For example, such integration need not exchange or use any PII data such as name, home address, IP address, and/or plain-text email address.

When analyzing the influence of impact of touchpoints on a user's engagement progression and possible conversion, a time-based progression view of the touchpoints and a stacked engagement contribution value of the touchpoints can be considered as shown in FIG. 2A, FIG. 2B1 and FIG. 2B2.

FIG. 2A presents an engagement stack progression chart 2A00 including offline and online touchpoints as used in systems for enhancing touchpoint attribution accuracy using offline data onboarding. As an option, one or more instances of engagement stack progression chart 2A00 or any aspect thereof may be implemented in the context of the architecture and functionality of the embodiments described herein. Also, the engagement stack progression chart 2A00 or any aspect thereof may be implemented in any desired environment.

The engagement stack progression chart 2A00 depicts a progression of touchpoints experienced by one or more users (e.g., user 105) in audience 110. Specifically, a user 1 engagement progress 212 and a user N engagement progress 214 are shown as representative the audience 110 (e.g., comprising user 1 to user N). The user 1 engagement progress 212 and the user N engagement progress 214 represent the user's progress from a state x₀ 220 to a state xₙ₊₁ 225 over a time τ₀ 230 to a time t 235. For example, the state x₀ 220 can represent an initial user engagement state and the state xₙ₊₁ 225 can represent a final user engagement state (e.g., conversion). Further, the time τ₀ 230 to the time t 235 can represent a measurement time window for performing touchpoint attribution analyses. The times depicted and discussed are all relative, and the sizes of the graphical elements used in the figures are not intended to correspond to any particular time scale. Moreover the positioning of the times (e.g., τ₀ 230 to the time t 235) are not intended to line up with any particular times or engagements within the shown user engagement processes.

As shown in user 1 engagement progress 212, user 1 might experience a touchpoint T1 201 (e.g., catalog ad 153 on an airplane). At some later moment, user 1 might experience a touchpoint T2 202 (e.g., product demo 156 on a mobile microsite). At yet another moment later in time, user 1 might experience a touchpoint T3 203₁ (e.g., product website 157). User 1 might then experience touchpoint T4 204 (e.g., digital coupon 158 received via email). User 1 can then experience touchpoint T5 205₁ (e.g., product display 152 at a retail store), at which time the user 1 reaches state xₙ₊₁ 225 (e.g., purchases the product). Also as shown in the user N engagement progress 214, user N might first experience a touchpoint T6 206 (e.g., web search), moving user N from state x₀ 220. User N might experience a touchpoint T3 203₂ (e.g., product website 157) having the same attributes as touchpoint T3 203₁. As shown, user N might move next to a touchpoint T5 205₂ (e.g., product display 152 at a retail store) having the same attributes as touchpoint T5 205₁.

As shown, touchpoint T1 201, touchpoint T5 205₁, and touchpoint T5 205₂, are derived from the onboarded offline data 176 discussed in FIG. 1. Using any of the herein-discussed approaches, the onboarded offline data 176 and associated touchpoints can be included in the user 1 engagement progress 212 and the user N engagement progress 214, resulting in a view of the engagement progression of user 1 and user N that is more complete and accurate. For example, using herein-disclosed approaches, both user 1 and user N can be known to have converted (e.g., see touchpoint T5 205₁ and touchpoint T5 205₂). Using the herein disclosed techniques, such legacy problems attendant to measuring the influence of both offline touchpoints and online touchpoints on user conversion are addressed. Specifically, the offline touchpoints and online touchpoints included in the engagement stack progression chart 2A00 can be analyzed to determine the contribution that a touchpoint and/or combination of touchpoints (e.g., engagement stack) has towards a target user response (e.g., conversion). Such an engagement stack is discussed as pertains to FIG. 2B.

FIG. 2B1 presents an engagement stack contribution value chart 2B100 as used in systems for enhancing touchpoint attribution accuracy using offline data onboarding. As an option, one or more instances of engagement stack contribution value chart 2B100 or any aspect thereof may be implemented in the context of the architecture and functionality of the embodiments described herein. Also, the engagement stack contribution value chart 2B100 or any aspect thereof may be implemented in any desired environment.

The engagement stack contribution value chart 2B100 shows the “stack” of contribution values (e.g., T1 touchpoint contribution value 241, T2 touchpoint contribution value 242, T3 touchpoint contribution value 243, T4 touchpoint contribution value 244, T5 touchpoint contribution value 245, and T6 touchpoint contribution value 246) of the respective touchpoints (e.g., T1, T2, T3, T4, T5, and T6, respectively) of engagement stack 210. The overall contribution value of the engagement stack 210 is defined by a total contribution value 240. Such contribution values indicate a measure of the influence attributed to a given touchpoint in transitioning a user from a first engagement state to a second engagement state. According to the herein disclosed techniques, the touchpoints included in engagement stack 210 can comprise touchpoints from online channels (e.g., T2, T3, T4, and T6), and touchpoints from offline channels (e.g., T1 and T5). For example, by onboarding the offline touchpoints, marketing managers can tie offline activity and purchase data with online marketing efforts to gain a more complete picture of media effectiveness. The engagement stack contribution value chart 2B100 depicts the progression or a journey taken by a single user. However, many users can share the same journey, and a widely-traversed progression or journey, in particular a highly-successful and widely-traversed journey to a conversion, can serve as a hypothesis for a desired engagement stack. Moreover, a marketing campaign can be designed or tuned so as to foster one particular highly-successful journey (e.g., resulting in a purchase event or other conversion event) over other possible journeys. The engagement stack contribution value chart of FIG. 2B2 depicts a progression or journey that is traversed by a plurality of users.

FIG. 2B2 presents an engagement stack contribution value chart 2B200 as used in systems for enhancing touchpoint attribution accuracy using offline data onboarding. 2B200 or any aspect thereof may be implemented in any desired environment.

The engagement stack contribution value chart 2B200 depicts a widely-traversed journey to conversions by a plurality of users. As shown, the total contribution value 240 can be associated with one or more users (e.g., see N users 252) traversing from an initial user engagement state (e.g., a state from which there is no pertinent user state data, such as depicted by state x₀ 220) to a conversion state (e.g., state xₙ₊₁ 225). In one or more embodiments, the touchpoint attribution for a set of respective audience segments traversing between state x₀ 220 and state xₙ₊₁ 225 can be determined. Such segmentation enables marketing managers to leverage the offline and online data to target prospective customers in the right place, at the right time, and with the right message.

The engagement stack contribution value chart 2B200 depicts dominating touchpoints of a particular sequence selected from many other sequences found among the possible traversal sequences of the N users. Certain traversals may pertain to particular aspects of user behaviors, and users who exhibit such behaviors can be considered to belong to a particular segmented audience. In some cases, audience segmentation can provide a truer representation of the contributions of particular touchpoints toward a desired state. Modeling techniques referred to herein as “look-alike modeling” extends audience segmentation so as to increase the size of an audience to include “look-alike” audience members who look alike for various reasons other than merely traversing the exact set and timing and order of the considered touchpoints (e.g., T1 through T5, as shown).

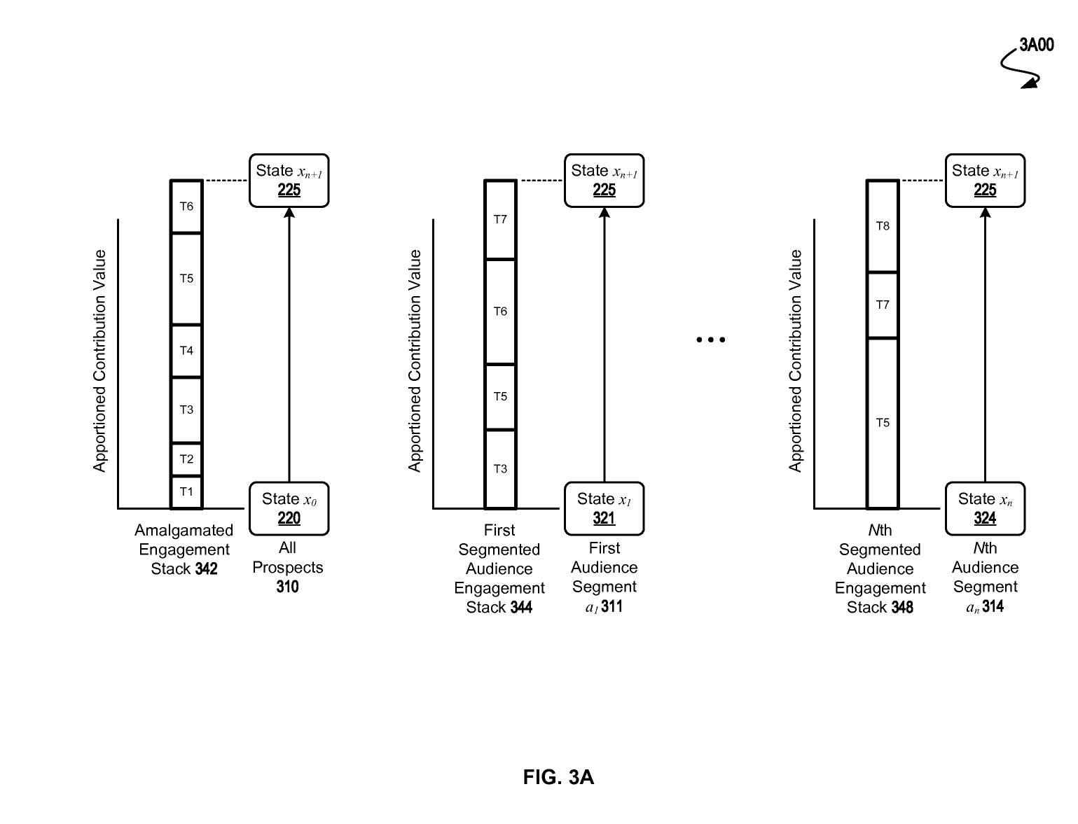

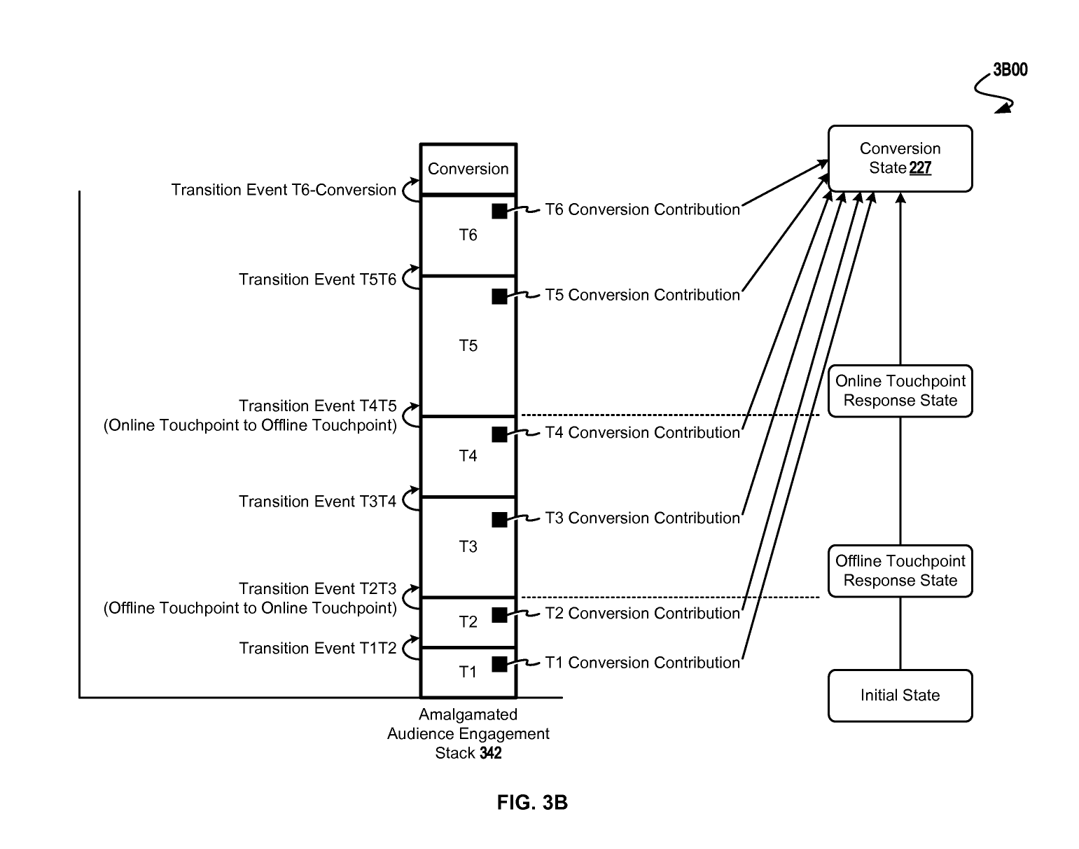

FIG. 3A presents an audience segment attribution model 3A00 as used in systems for enhancing touchpoint attribution accuracy using offline data onboarding. As an option, one or more instances of audience segment attribution model 3A00 or any aspect thereof may be implemented in the context of the architecture and functionality of the embodiments described herein. Also, the audience segment attribution model 3A00 or any aspect thereof may be implemented in any desired environment.

One application of the audience segment attribution model 3A00 is look-alike modeling. Look-alike models identify segments of individuals that behave in a certain way. Look-alike segments may be created over data obtained by combining transactional data associated with customers, with media performance data and customer demographic information (e.g., collected from transactions, surveys, third-party data providers, etc.). Using look-alike modeling techniques, marketing managers can determine which segments have the highest lifetime value (e.g., LTV), which segments have the highest propensity to convert, and which tactics are most efficient for a given segment and for a given state of the engagement progress. For example, look-alike modeling can help determine which channel, publisher and offer serves as the first touch (e.g., “introducer” at state x₀ 220) for the customer segment with the highest LTV. Further, look-alike modeling can help determine which combination of tactics (e.g., ads, content, touchpoints, stimulus, etc.) serves as the last touch for the segment with the highest propensity to be repeat buyers. With such information, marketing managers can not only determine which tactics produce the highest results by customer segment, but can also prescribe at which engagement state and in which sequence those tactics should be executed.

As an example, the audience segment attribution model 3A00 shows the relative contribution values of various touchpoints that contributed to transitioning a segment of users from a first engagement state to a second engagement state. More specifically, audience segment attribution model 3A00 depicts an amalgamated engagement stack 342 (e.g., comprising touchpoints T1, T2, T3, T4, T5, and T6 from FIG. 2A) that contributed to transitioning the set of all prospects 310 from the state x₀ 220 to the state xₙ₊₁ 225 (e.g., conversion). Also shown is a first segmented audience engagement stack 344 (e.g., comprising touchpoints T3, T5, T6, and T7) that contributed to transitioning the first audience segment a₁ 311 from the state x₁ 321 to the state xₙ₊₁ 225 (e.g., conversion). To exemplify, touchpoint T6 might correspond to an online web search, and touchpoint T7 might correspond to an online store associated with a retail store. Further shown is an Nth segmented audience engagement stack 348 (e.g., comprising touchpoints T5, T7, and T8) that contributed to transitioning an Nth audience segment aₙ 314 from the state xₙ 324 to the state xₙ₊₁ 225 (e.g., conversion). To exemplify, touchpoint T8 might correspond to a mobile ad received while at a retail store. Other audience segments and respective attributions (e.g., touchpoint engagement stacks) are possible.

As shown, by segmenting the campaign into a plurality of audience segments and determining the touchpoint attributions for the respective audience segments, the marketing manager is able to discern that different engagement stacks (e.g., first segmented audience engagement stack 344, an Nth segmented audience engagement stack 348, and so on) are associated with different audience segments (e.g., first audience segment a₁ 311, and an Nth audience segment aₙ 314, respectively). The constituents of those users within a particular audience segment can be said to be “look alike users” in a look-alike model.

In considering the variations between several segmented audience engagement stacks, a marketing manager might decide to allocate media spending according to the contributing touchpoints comprising the first segmented audience engagement stack 344 if an increase in ROI for conversions is desired. Comparatively, if the marketing manager only analyzed the response of the set of all prospects 310 (e.g., see amalgamated engagement stack 342), then the marketing manager might allocate media spend less optimally (e.g., since spend would be allocated to touchpoint that are not contributing to conversions by constituents of the desired second audience).

In the examples shown, the users in a first audience segment a₁ 311 are modeled to begin in state x₁ 321. Further, the associated first segmented audience engagement stack 344 shows that the contributing touchpoints T3, T5, T6, and T7 influence conversion, yet touchpoints T1, T2, T4, and T8 do not influence conversion. Deploying one or more of touchpoints T1, T2, T4, and T8 would not be an effective apportionment of media spend for reaching first audience segment a₁ 311. As another example, the users in the Nth audience segment aₙ 314 are modeled to begin in state xₙ 324. For example, the Nth audience segment aₙ 314 can comprise users on their way to the retail store with an intent to purchase a given product. In this case, the catalog ad 153 (e.g., touchpoint T1), the product demo 156 (e.g., touchpoint T3), and/or other touchpoints targeted for users at earlier engagement states might not be effective. Yet, the Nth segmented audience engagement stack 348 shows that other contributing touchpoints (e.g., retail store T5 or the product display of T7, or an online store associated with the retail store at touchpoint T8, or a mobile ad received while at the retail store, etc.) can be effective in converting the users in Nth audience segment aₙ 314.

A particular individual user or group of users or other segment of an audience might reach conversion through different paths and/or through a different series of states reached by traversal through different combinations of touchpoints. A number of actually observed traversals through different combinations of touchpoints can be enumerated and ranked. Any one or more of the top-ranked traversals through touchpoints can be used as a template over a corpus of user records, and users who have traversed through a particular permutation of touchpoints can be deemed to be a segmented audience. Any of the herein-described audience segment attribution models can be applied over a particular segmented audience. In some cases, look-alike modeling can be used to augment the size of a segmented audience. For example, using the heretofore described technique of selecting a segmented audience based on a particular permutation of touchpoints, a set of common characteristics gleaned from the audience members of the segmented audience can be identified and, based on a hypothesis that “users that fit into a particular look-alike model would respond similarly to the same stimulus”, a media spend recommendation can be made so as to apportion spending to combinations of touchpoints that achieve a high degree of conversions.

Further details related to look-alike modeling based on similar touchpoint interaction experiences are disclosed in U.S. Patent Application Ser. No. 62/098,159, entitled “REAPPORTIONING SPENDING IN AN ADVERTISING CAMPAIGN BASED ON A SEQUENCE OF USER INTERACTIONS” (Attorney Docket No. VISQ.P0015P), filed on Dec. 30, 2014, which is hereby incorporated by reference in its entirety.

Further details related to formation of pools of similarly-scored cookies score are disclosed in U.S. patent application Ser. No. 14/585,728, entitled “VALIDATION OF BOTTOM-UP ATTRIBUTIONS TO CHANNELS IN AN ADVERTISING CAMPAIGN” (Attorney Docket No. VISQ.P0011), filed on Dec. 30, 2014, which is hereby incorporated by reference in its entirety.

FIG. 3B presents an audience segment attribution model 3B00 used in systems for enhancing touchpoint attribution accuracy using offline data onboarding. As an option, one or more instances of audience segment attribution model 3B00 or any aspect thereof may be implemented in the context of the architecture and functionality of the embodiments described herein. Also, the audience segment attribution model 3B00 or any aspect thereof may be implemented in any desired environment.

The audience segment attribution model 3B00 includes annotations of transition events (e.g., transition event T1T2, transition event T2T3, etc.) as well as annotations of conversion contribution values (e.g., T1 conversion contribution, T2 contribution, etc.). The relative height of each of the depicted touchpoints T1, T2, etc. are indicative of the relative contribution of the respective touchpoint to achieving a conversion (e.g., see the arrows indicating desired transition to the conversion state 227).

A chart or model such as the shown audience segment attribution model 3B00 can be constructed by collating user records that correspond to an audience of users, individual users from which audience have interacted with touchpoints. A user interaction with a touchpoint can often be detected, measured and codified into interaction touchpoint records. In some cases, the user interaction is from an online touchpoint and the observations and/or measurements can be made at the time of the interaction. In other cases, the user interaction is from an offline touchpoint and the observations and/or measurements can collected by an agent and onboarded (e.g., see onboarded offline data 176). Exemplary interaction touchpoint records capture at least dates and/or times of occurrences of events pertaining to user interactions with respective touchpoints. Such events pertaining to user interactions with respective touchpoints often comprise response data. Response data can arise from occurrences of online touchpoint interactions and/or can arise from occurrences of offline touchpoint interactions. In some cases, all response data can arise from occurrences offline touchpoint interactions, and hence all transitions in a touchpoint stack are from a first offline touchpoint interaction to a different offline touchpoint interaction.

Given such user interaction data, transitions from a first engagement state to a second engagement state can be determined, either for a particular user or for a group of users. In some cases, using the times of occurrences of events pertaining to the user interactions with the respective touchpoints, a segmented audience can be constructed (e.g., including only audience members who moved from one state to another state) within some given time period (e.g., on the same day, or within the same hour). Knowing the touchpoints that were measurably traversed during the progression to a conversion, and knowing the frequency and/or likelihood of transitions from one touchpoint to another touchpoint, a contribution value for each touchpoint can be calculated. In some embodiments, codification of the aforementioned frequency and/or likelihood of transitions from one touchpoint to another touchpoint allows the codified transitions to be input into a function that quantifies a measure of influence attributed to a respective one of the interaction touchpoints.

Transitions from an offline touchpoint to an online touchpoint can be handled separately from transitions from an online touchpoint to an offline touchpoint. Further, multiple transitions between touchpoints can occur between a first state and a conversion state. Still further, a touchpoint contribution value can be apportioned based (e.g., inversely) on the amount of time that an audience of users spends in a particular state. For example, if a user or group of users sees an offline product demo on a particular date and time, and there is a corresponding contemporaneous flood of coupon downloads, followed by measured purchases the same hour, then the offline product demo touchpoint might receive a relatively higher apportionment than other touchpoints in the touchpoint stack. Apportionments can be used to form a media spend recommendation. Such apportionments and/or media spend recommendations can be based on the contribution values of an online touchpoint reached by a transition from an offline touchpoint, or based on the contribution values of an offline touchpoint reached by a transition from an online touchpoint.

### Additional Practical Application Examples

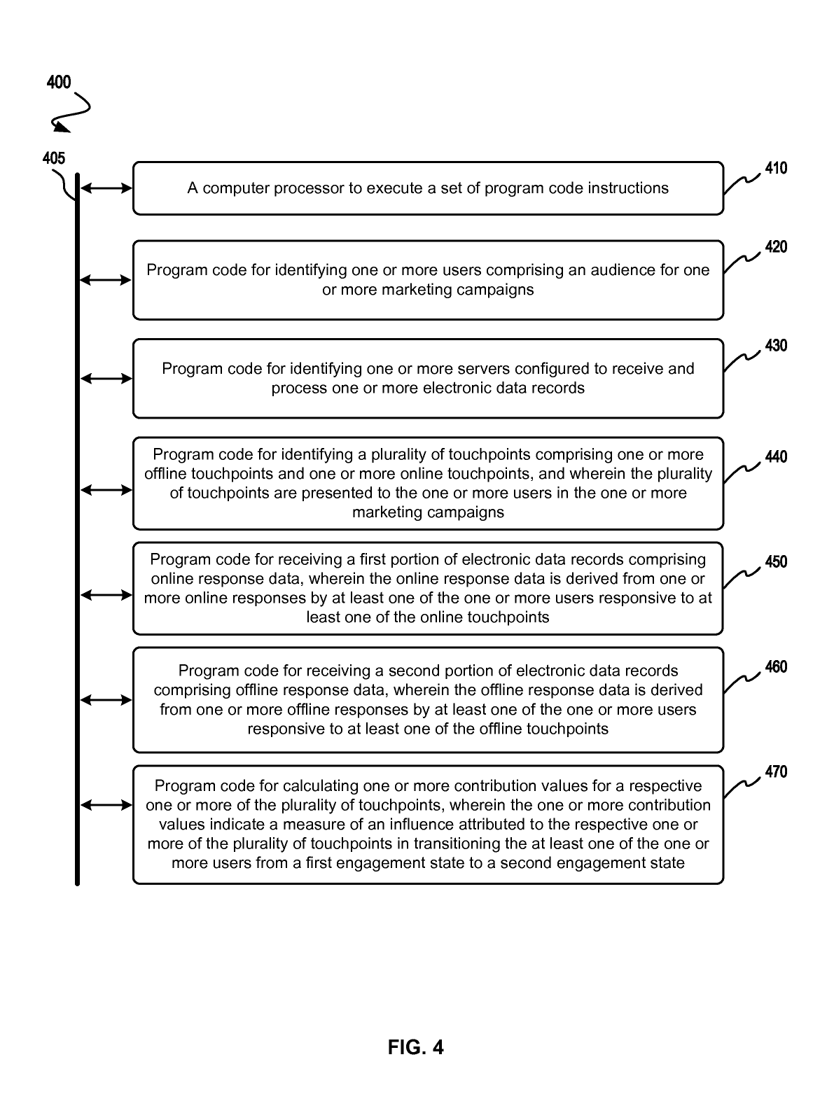

FIG. 4 is a block diagram of a system for enhancing touchpoint attribution accuracy using offline data onboarding, according to an embodiment. As an option, the present system 400 may be implemented in the context of the architecture and functionality of the embodiments described herein. Of course, however, the system 400 or any operation therein may be carried out in any desired environment.

The system 400 comprises at least one processor and at least one memory, the memory serving to store program instructions corresponding to the operations of the system. As shown, an operation can be implemented in whole or in part using program instructions accessible by a module. The modules are connected to a communication path 405, and any operation can communicate with other operations over communication path 405. The modules of the system can, individually or in combination, perform method operations within system 400. Any operations performed within system 400 may be performed in any order unless as may be specified in the claims.

The shown embodiment implements a portion of a computer system, presented as system 400, comprising a computer processor to execute a set of program code instructions (see module 410) and modules for accessing memory to hold program code instructions to perform: identifying one or more users comprising an audience for one or more marketing campaigns (see module 420); identifying one or more servers configured to receive and process one or more electronic data records (see module 430); identifying a plurality of touchpoints comprising one or more offline touchpoints and one or more online touchpoints, and wherein the plurality of touchpoints are presented to the one or more users in the one or more marketing campaigns (see module 440); receiving a first portion of electronic data records comprising online response data, wherein the online response data is derived from one or more online responses by at least one of the one or more users responsive to at least one of the online touchpoints (see module 450); receiving a second portion of electronic data records comprising offline response data, wherein the offline response data is derived from one or more offline responses by at least one of the one or more users responsive to at least one of the offline touchpoints (see module 460); and calculating one or more contribution values for a respective one or more of the plurality of touchpoints, wherein the one or more contribution values indicate a measure of an influence attributed to the respective one or more of the plurality of touchpoints in transitioning the at least one of the one or more users from a first engagement state to a second engagement state (see module 470).

### Additional System Architecture Examples

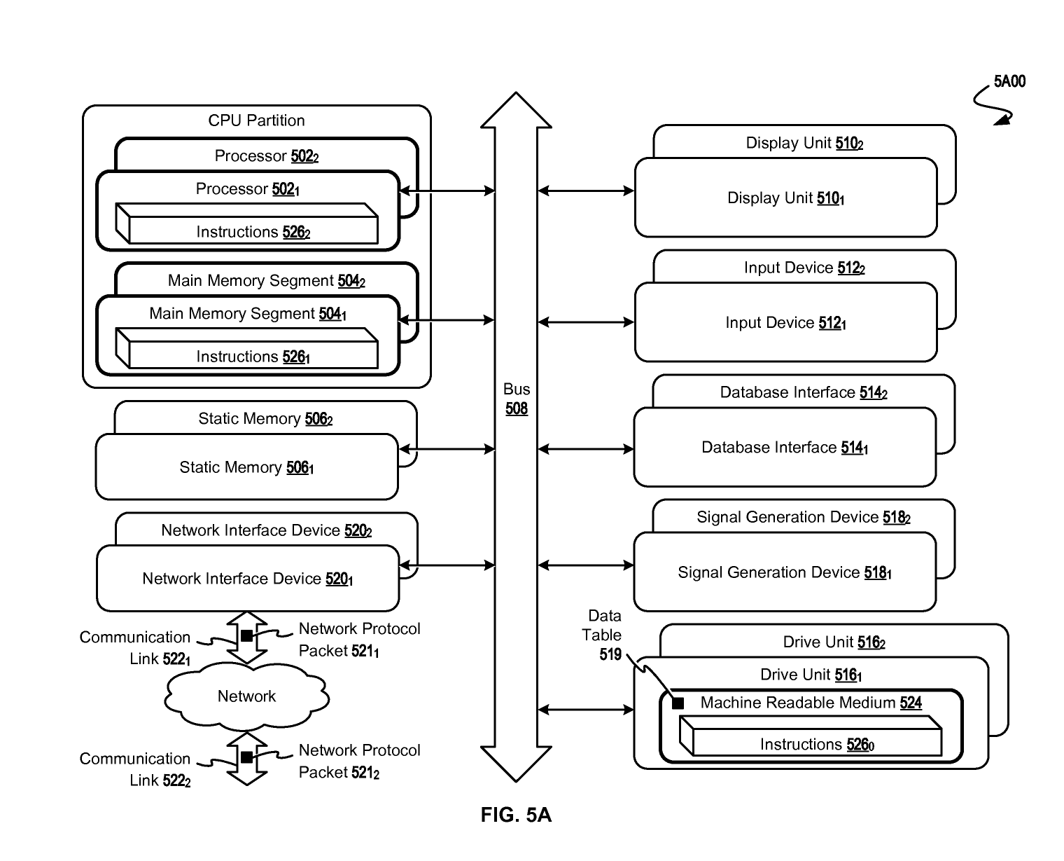

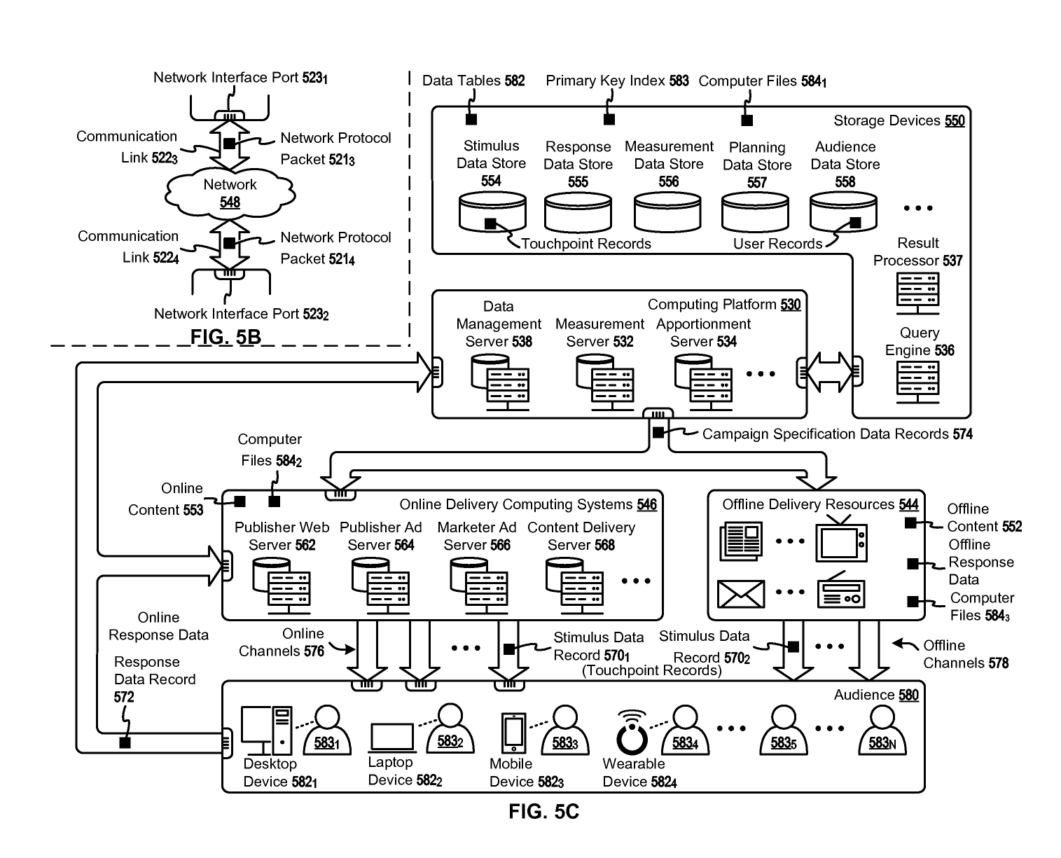

FIG. 5A depicts a diagrammatic representation of a machine in the exemplary form of a computer system 5A00 within which a set of instructions for causing the machine to perform any one of the methodologies discussed above may be executed. In alternative embodiments, the machine may comprise a network router, a network switch, a network bridge, personal digital assistant (PDA), a cellular telephone, a web appliance or any machine capable of executing a sequence of instructions that specify actions to be taken by that machine.

The computer system 5A00 includes one or more processors (e.g., processor 502₁, processor 502₂, etc.), a main memory comprising one or more main memory segments (e.g., main memory segment 504₁, main memory segment 504₂, etc.), one or more static memories (e.g., static memory 506₁, static memory 506₂, etc.), which communicate with each other via a bus 508. The computer system 5A00 may further include one or more video display units (e.g., display unit 510₁, display unit 510₂, etc.), such as an LED display, or a liquid crystal display (LCD), or a cathode ray tube (CRT). The computer system 5A00 can also include one or more input devices (e.g., input device 512₁, input device 512₂, alphanumeric input device, keyboard, pointing device, mouse, etc.), one or more database interfaces (e.g., database interface 514₁, database interface 514₂, etc.), one or more disk drive units (e.g., drive unit 516₁, drive unit 516₂, etc.), one or more signal generation devices (e.g., signal generation device 518₁, signal generation device 518₂, etc.), and one or more network interface devices (e.g., network interface device 520₁, network interface device 520₂, etc.).

The disk drive units can include one or more instances of a machine-readable medium 524 on which is stored one or more instances of a data table 519 to store electronic information records. The machine-readable medium 524 can further store a set of instructions 526₀ (e.g., software) embodying any one, or all, of the methodologies described above. A set of instructions 526₁ can also be stored within the main memory (e.g., in main memory segment 504₁). Further, a set of instructions 526₂ can also be stored within the one or more processors (e.g., processor 502₁). Such instructions and/or electronic information may further be transmitted or received via the network interface devices. Specifically, the network interface devices can communicate electronic information across a network using one or more communication links (e.g., communication link 522₁, communication link 522₂, etc.). One or more network protocol packets (e.g., network protocol packet 521₁, network protocol packet 521₂, etc.) can be used to hold the electronic information (e.g., electronic data records) for transmission across the network.

The computer system 5A00 can be used to implement a client system and/or a server system, and/or any portion of network infrastructure.

It is to be understood that various embodiments may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; or any other type of non-transitory media suitable for storing or transmitting information.

A module as used herein can be implemented using any mix of any portions of the system memory, and any extent of hard-wired circuitry including hard-wired circuitry embodied as one or more processors (e.g., processor 502₁, processor 502₂, etc.).

FIG. 5B and FIG. 5C depict block diagrams of a marketing data processing system suitable for implementing instances of the herein-disclosed embodiments. The marketing data processing system may include many more or fewer components than those shown.

The components of the marketing data processing system may communicate electronic information (e.g., electronic data records) across various instances and/or types of an electronic communications network (e.g., network 548) using one or more optical links, Ethernet links, wireline links, wireless links, and/or other electronic communication links (e.g., communication link 522₃, communication link 522₄, etc.). Such communication links may further use supporting hardware, such as modems, bridges, routers, switches, wireless antennas and towers, and/or other supporting hardware. In some embodiments, the network 548 may include, without limitation, the web (i.e., the Internet), one or more local area networks (LANs), one or more wide area networks (WANs), one or more wireless networks, and/or one or more cellular networks. The various communication links transmit signals comprising data and commands (e.g., electronic data records) exchanged by the components of the marketing data processing system 5B00, as well as any supporting hardware devices used to transmit the signals. In some embodiments, such signals are transmitted and received by the components at one or more network interface ports (e.g., network interface port 523₁, network interface port 523₂, etc.). In one or more embodiments, one or more network protocol packets (e.g., network protocol packet 521₃, network protocol packet 521₄, etc.) can be used to hold the electronic information comprising the signals.

As shown, the marketing data processing system can be used by one or more advertisers to target a set of users (e.g., user 583₁, user 583₂, user 583₃, user 583₄, user 583₅, to user 583_{N}) comprising an audience 580 in various marketing campaigns. The marketing data processing system can further be used to determine, by a computing platform 530, various attributes of such marketing campaigns. Other operations, transactions, and/or activities associated with the marketing data processing system are possible. Specifically, the users in audience 580 can experience a plurality of online content 553 transmitted through any of a plurality of online channels 576 (e.g., online display, search, mobile ads, etc.) to various computing devices (e.g., desktop device 582₁, laptop device 582₂, mobile device 582₃, and wearable device 582₄). The users in audience 580 can further experience a plurality of offline content 552 presented through any of a plurality of offline channels 578 (e.g., TV, radio, print, direct mail, etc.). The online content 553 and/or the offline content 552 can be selected for delivery to the audience 580 based in part on certain instances of campaign specification data records 574 (e.g., established by the advertisers and/or the computing platform 530). For example, the campaign specification data records 574 might comprise settings, rules, taxonomies, and other information transmitted electronically to one or more instances of online delivery computing systems 546 and/or one or more instances of offline delivery resources 544. The online delivery computing systems 546 and/or the offline delivery resources 544 can receive and store such electronic information in the form of instances of computer files 584₂ and computer 584₃, respectively. In one or more embodiments, the online delivery computing systems 546 can comprise computing resources such as a publisher web server 562, a publisher ad server 564, a marketer ad server 566, a content delivery server 568, and other computing resources. For example, the stimulus data record 570₁ presented to the users of audience 580 through the online channels 576 can be transmitted through the communications links of the marketing data processing system as instances of electronic data records using various protocols (e.g., HTTP, HTTPS, etc.) and structures (e.g., JSON), and rendered on the computing devices in various forms (e.g., digital picture, hyperlink, advertising tag, text message, email message, etc.). The stimulus data record 570₂ presented to the users of audience 580 through the offline channels 578 can be transmitted as sensory signals in various forms (e.g., printed pictures and text, video, audio, etc.).

The computing platform 530 can receive instances of response data record 572 comprising certain characteristics and attributes of the response of the users in audience 580 to the stimulus data record 570₁ and the stimulus data record 570₂. For example, the response data record 572 can describe certain online actions taken by the users on the computing devices, such as visiting a certain URL, clicking a certain link, loading a web page that fires a certain advertising tag, completing an online purchase, and other actions. The response data record 572 may also include information pertaining to certain offline actions taken by the users, such as a purchasing a product in a retail store, using a printed coupon, dialing a toll-free number, and other actions. The response data record 572 can be transmitted to the computing platform 530 across the communications links as instances of electronic data records using various protocols and structures. The response data record 572 can further comprise data (e.g., computing device identifiers, timestamps, IP addresses, etc.) related to the users' actions.

The response data record 572 and other data generated and used by the computing platform 530 can be stored in one or more storage devices 550 (e.g., stimulus data store 554, response data store 555, measurement data store 556, planning data store 557, audience data store 558, etc.). The storage devices 550 can comprise one or more databases and/or other types of non-volatile storage facilities to store data in various formats and structures (e.g., data tables 582, computer files 584₁, etc.). The data stored in the storage devices 550 can be made accessible to the computing platform by a query engine 536 and a result processor 537, which can use various means for accessing and presenting the data, such as a primary key index 583 and/or other means. In one or more embodiments, the computing platform 530 can comprise a measurement server 532 and an apportionment server 534. Operations performed by the measurement server 532 and the apportionment server 534 can vary widely by embodiment. As an example, the measurement server 532 can be used to analyze the stimuli presented to the users (e.g., stimulus data record 570₁ and stimulus data record 570₂) and the associated instances of response data record 572 to determine various performance metrics associated with a marketing campaign, which metrics can be stored in the measurement data store 556 and/or used to generate various instances of the campaign specification data records 574. Further, for example, the apportionment server 534 can be used to generate marketing campaign plans and associated marketing spend apportionment, which information can be stored in the planning data store 557 and/or used to generate various instances of the campaign specification data records 574. Certain portions of the response data record 572 might further be used by a data management server 538 in the computing platform 530 to determine various user attributes (e.g., behaviors, intent, demographics, device usage, etc.), which attributes can be stored in the audience data store 558 and/or used to generate various instances of the campaign specification data records 574.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A computer implemented method comprising:
receiving a set of user records corresponding to an audience of users;
identifying a plurality of interaction touchpoint records comprising one or more offline touchpoint records and one or more online touchpoint records, wherein the plurality of interaction touchpoint records capture at least times of occurrences of events pertaining to user interactions with a respective one or more touchpoints;
identifying a first set of electronic data records comprising online response data, wherein the online response data is derived from the one or more online touchpoint records;
identifying a second set of electronic data records comprising offline response data, wherein the offline response data is derived from the one or more offline touchpoint records;
determining one or more transitions from a first engagement state to a second engagement state using the times of occurrences of events pertaining to the user interactions with the respective touchpoints; and
calculating contribution values corresponding to respective one or more of the plurality of interaction touchpoint records, wherein the contribution values quantify audience influence attributed to a respective one of the plurality of interaction touchpoint records.

2. The method of claim 1, wherein the transition from the first engagement state to the second engagement state is a transition from an offline touchpoint to an online touchpoint.

3. The method of claim 2, wherein the second engagement state is a conversion state.

4. The method of claim 1, wherein at least one of the transitions from a first engagement state to a second engagement state is a transition from an offline touchpoint to an online touchpoint.

5. The method of claim 1, further comprising apportioning a media spend recommendation value based at least in part on the contribution values of an online touchpoint reached by a transition from an offline touchpoint.

6. The method of claim 1, wherein at least one of the transitions from a first engagement state to a second engagement state is a transition from an online touchpoint to an offline touchpoint.

7. The method of claim 1, further comprising apportioning a media spend recommendation value based at least in part on the contribution values of an offline touchpoint reached by a transition from an offline touchpoint.

8. The method of claim 7, further comprising apportioning media spend based at least in part on a sequence of contributing touchpoints.

9. The method of claim 8, further comprising apportioning media spend based at least in part on a demographic shared by users who traverse the sequence of contributing touchpoints.

10. The method of claim 8, further comprising apportioning media spend based at least in part on a frequency of occurrence of the sequence of contributing touchpoints.

11. A computer program product, embodied in a non-transitory computer readable medium, the non-transitory computer readable medium having stored thereon a sequence of instructions which, when stored in memory and executed by a processor causes the processor to perform a set of acts, the acts comprising:
receiving a set of user records corresponding to an audience of users;
identifying a plurality of interaction touchpoint records comprising one or more offline touchpoint records and one or more online touchpoint records, wherein the plurality of interaction touchpoint records capture at least times of occurrences of events pertaining to user interactions with a respective one or more touchpoints;
identifying a first set of electronic data records comprising online response data, wherein the online response data is derived from the one or more online touchpoint records;
identifying a second set of electronic data records comprising offline response data, wherein the offline response data is derived from the one or more offline touchpoint records;
determining one or more transitions from a first engagement state to a second engagement state using the times of occurrences of events pertaining to the user interactions with the respective touchpoints; and
calculating contribution values corresponding to respective one or more of the plurality of interaction touchpoint records, wherein the contribution values quantify audience influence attributed to a respective one of the plurality of interaction touchpoint records.

12. The computer program product of claim 11, wherein the transition from the first engagement state to the second engagement state is a transition from an offline touchpoint to an online touchpoint.

13. The computer program product of claim 12, wherein the second engagement state is a conversion state.

14. The computer program product of claim 11, wherein at least one of the transitions from a first engagement state to a second engagement state is a transition from an offline touchpoint to an online touchpoint.

15. The computer program product of claim 11, further comprising instructions which, when loaded into memory and executed by the processor cause the acts of apportioning a media spend recommendation value based at least in part on the contribution values of an online touchpoint reached by a transition from an offline touchpoint.

16. The computer program product of claim 11, wherein at least one of the transitions from a first engagement state to a second engagement state is a transition from an online touchpoint to an offline touchpoint.

17. The computer program product of claim 11, further comprising instructions which, when loaded into memory and executed by the processor cause the acts of apportioning a media spend recommendation value based at least in part on the contribution values of an offline touchpoint reached by a transition from an offline touchpoint.

18. The computer program product of claim 17, further comprising instructions which, when loaded into memory and executed by the processor cause the acts of apportioning media spend based at least in part on a sequence of contributing touchpoints.

19. A system comprising:
an audience data store to receive a set of user records corresponding to an audience of users;
a server configured to carry out steps of:
identifying a plurality of interaction touchpoint records comprising one or more offline touchpoint records and one or more online touchpoint records, wherein the plurality of interaction touchpoint records capture at least times of occurrences of events pertaining to user interactions with a respective one or more touchpoints;
identifying a first set of electronic data records comprising online response data, wherein the online response data is derived from the one or more online touchpoint records;
identifying a second set of electronic data records comprising offline response data, wherein the offline response data is derived from the one or more offline touchpoint records;
determining one or more transitions from a first engagement state to a second engagement state using the times of occurrences of events pertaining to the user interactions with the respective touchpoints; and
calculating contribution values corresponding to respective one or more of the plurality of interaction touchpoint records, wherein the contribution values quantify audience influence attributed to a respective one of the plurality of interaction touchpoint records.

20. The system of claim 19, wherein the transition from the first engagement state to the second engagement state is a transition from an offline touchpoint to an online touchpoint.
